(19) United States
(12) Patent Application Publication
(10) Pub. No.: US 2012/0194636 A1
(43) Pub. Date: Aug. 2, 2012

(54) INFORMATION PROCESSING APPARATUS, INFORMATION PROCESSING METHOD, PROGRAM, AND IMAGING APPARATUS

(75) Inventors: Nodoka Tokunaga, Tokyo (JP); Kazushi Sato, Kanagawa (JP); Jun Murayama, Tokyo (JP)

(73) Assignee: SONY CORPORATION, Tokyo (JP)

(21) Appl. No.: 13/355,698

(22) Filed: Jan. 23, 2012

(30) Foreign Application Priority Data
Jan. 31, 2011 (JP) P2011-019138

(51) Int. Cl. H04N 7/00

(52) U.S. Cl. 348/36; 348/E07.091

(57) ABSTRACT

An information processing apparatus includes a calculation unit, a setting unit, a retrieval unit, an arrangement unit, a determination unit, and a notification unit. The calculation unit is configured to calculate a display range of an input image. The setting unit is configured to set an inclusive range including at least a part of the calculated display range. The retrieval unit is configured to retrieve an image to be combined that is associated with the input image. The arrangement unit is configured to arrange the retrieved image to be combined in the inclusive range. The determination unit is configured to determine an area within the inclusive range, in which the image to be combined is not arranged, as an image-missing area. The notification unit is configured to notify a user of information on the determined image-missing area.

### BACKGROUND

The present disclosure relates to an information processing apparatus, an information processing method, a program, and an imaging apparatus that are capable of combining a plurality of images.

In the past, a technique of combining images shot by a digital camera or the like to generate a panoramic image has been known. Such a panoramic image generation technique is disclosed in Japanese Patent Application Laid-open Nos. 2004-135230 (hereinafter, referred to as Patent Document 1) and 2005-217785 (hereinafter, referred to as Patent Document 2).

### SUMMARY

The techniques disclosed in Patent Documents 1 and 2 above reduce a user burden caused when a plurality of images to be combined to generate a panoramic image are selected. Such a technique that reduces a user burden and can generate a panoramic image with excellent operability has been demanded.

In view of the circumstances as described above, it is desirable to provide an information processing apparatus, an information processing method, a program, and an imaging apparatus that are capable of generating a combined image such as a panoramic image with excellent operability.

According to an embodiment of the present disclosure, there is provided an information processing apparatus including a calculation unit, a setting unit, a retrieval unit, an arrangement unit, a determination unit, and a notification unit.

The calculation unit is configured to calculate a display range of an input image.

The setting unit is configured to set an inclusive range including at least a part of the calculated display range.

The retrieval unit is configured to retrieve an image to be combined that is associated with the input image.

The arrangement unit is configured to arrange the retrieved image to be combined in the inclusive range.

The determination unit is configured to determine an area within the inclusive range, in which the image to be combined is not arranged, as an image-missing area.

The notification unit is configured to notify a user of information on the determined image-missing area.

In the information processing apparatus, the display range of the input image is calculated, and the inclusive range including at least a part of the display range is set. Then, the image associated with the input image is retrieved as an image to be combined, and arranged in the inclusive range. At this time, the area in which the image to be combined is not arranged is determined as an image-missing area, and the user is notified of information on the area. Therefore, it is possible to easily prepare an image to be allocated to the image-missing area based on the notification, and by combination of those images, it is possible to generate a combined image such as a panoramic image with excellent operability.

The arrangement unit may arrange the image to be combined in the inclusive range based on relevance with the input image.

Accordingly, a combined image can be generated with high accuracy.

The notification unit may notify the user of the determined image-missing area in a visualized manner.

Accordingly, the image-missing area can be visually recognized.

The notification unit may notify the user of support information including at least information on a shooting position and a shooting direction, the support information being used for capturing an image to be allocated to the determined image-missing area.

Accordingly, the image to be allocated to the image-missing area can be easily captured based on the support information.

The information processing apparatus may further include a generation unit configured to generate an interpolation image for interpolating the image-missing area.

In such a manner, the combined image may be generated using the interpolation image to interpolate the image-missing area.

The information processing apparatus may further include a connection unit configured to be connectable via a network to a different information processing apparatus storing one or more images. In this case, the retrieval unit may retrieve via the network the image to be combined from the one or more images stored in the different information processing apparatus.

In such a manner, the image to be combined may be retrieved from the different information processing apparatus via the network. Accordingly, a more appropriate image as an image to be combined can be retrieved from many images.

According to another embodiment of the present disclosure, there is provided an information processing method including calculating, by a calculation unit, a display range of an input image.

By a setting unit, an inclusive range including at least a part of the calculated display range is set.

By the retrieval unit, an image to be combined that is associated with the input image is retrieved.

By the arrangement unit, the retrieved image to be combined is arranged in the inclusive range.

By the determination unit, an area within the inclusive range, in which the image to be combined is not arranged, is determined as an image-missing area.

By the notification unit, a user is notified of information on the determined image-missing area.

According to another embodiment of the present disclosure, there is provided a program causing a computer to function as a calculation unit, a setting unit, a retrieval unit, an arrangement unit, a determination unit, and a notification unit.

The calculation unit is configured to calculate a display range of an input image.

The setting unit is configured to set an inclusive range including at least a part of the calculated display range.

The retrieval unit is configured to retrieve an image to be combined that is associated with the input image.

The arrangement unit is configured to arrange the retrieved image to be combined in the inclusive range.

The determination unit is configured to determine an area within the inclusive range, in which the image to be combined is not arranged, as an image-missing area.

The notification unit is configured to notify a user of information on the determined image-missing area.

According to another embodiment of the present disclosure, there is provided an imaging apparatus including an imaging unit, a calculation unit, a setting unit, a retrieval unit, an arrangement unit, a determination unit, and a notification unit.

The imaging unit is configured to capture an image.

The calculation unit is configured to calculate a shooting range of the captured image.

The setting unit is configured to set an inclusive range including at least a part of the calculated shooting range.

The retrieval unit is configured to retrieve an image to be combined that is associated with the captured image.

The arrangement unit is configured to arrange the retrieved image to be combined in the inclusive range.

The determination unit is configured to determine an area within the inclusive range, in which the image to be combined is not arranged, as an image-missing area.

The notification unit is configured to notify a user of information on the determined image-missing area.

As described above, according to the present disclosure, a combined image such as a panoramic image can be generated with excellent operability.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram showing a configuration example of a network system including a server as an information processing apparatus according to an embodiment of the present disclosure;

FIG. 2 is a block diagram showing an example of a hardware configuration of an imaging apparatus shown in FIG. 1;

FIG. 3 is a block diagram showing an example of a hardware configuration of the server according to the embodiment;

FIG. 4 is a block diagram showing a functional configuration example of the imaging apparatus shown in FIG. 1;

FIG. 5 is a diagram schematically showing a configuration example of an image file transmitted from an image information transmission unit shown in FIG. 4;

FIG. 6 is a block diagram showing a functional configuration example of the server according to the embodiment;

FIG. 7 is a block diagram showing a configuration example of an image combination unit shown in FIG. 6;

FIG. 8 is a flowchart showing the operation of the server according to the embodiment;

FIG. 9 is a diagram for describing the steps shown in FIG. 8;

FIG. 10 is a flowchart showing an example of shooting range calculation processing according to the embodiment;

FIG. 11 is a diagram for describing the shooting range calculation processing shown in FIG. 10;

FIG. 12 is a diagram for describing the shooting range calculation processing shown in FIG. 10;

FIG. 13 is a flowchart showing an example of image retrieval processing by an image retrieval unit shown in FIG. 6;

FIG. 14 is a diagram for describing the image retrieval processing shown in FIG. 13;

FIG. 15 is a flowchart showing an example of image collection processing by an image collection unit shown in FIG. 6;

FIG. 16 is a flowchart showing panoramic image generation processing and generation processing for interpolation images or the like performed by the image combination unit shown in FIG. 6;

FIG. 17 is a diagram for describing magnification correction processing shown in FIG. 16;

FIG. 18 is a schematic diagram showing an allocation map according to the embodiment;

FIG. 19 is a diagram for describing allocation processing for a combination candidate image according to the embodiment;

FIG. 20 is a diagram schematically showing a panoramic image generated by a technique according to the embodiment;

FIG. 21 is a diagram schematically showing an area-missing image according to the embodiment;

FIG. 22 is a table schematically showing an example of support information generated by a support information generation unit shown in FIG. 7;

FIG. 23 is a diagram schematically showing an interpolated panoramic image in which image-missing areas shown in FIG. 21 are interpolated by using interpolation images;

FIG. 24 is a diagram showing an example of a support method using the support information at a time when an image to cover the image-missing area shown in FIG. 21 is captured; and

FIG. 25 is a schematic diagram showing a modified example of the network system shown in FIG. 1.

### DETAILED DESCRIPTION OF EMBODIMENTS

Hereinafter, an embodiment of the present disclosure will be described with reference to the drawings.

### [Configuration of Network System]

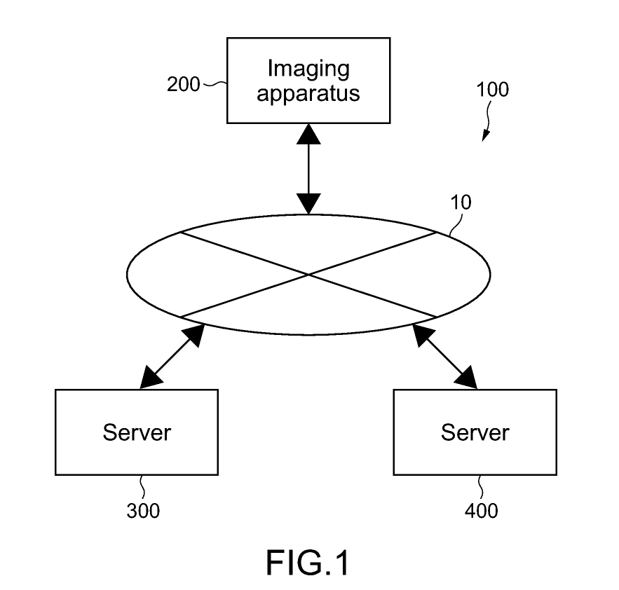

FIG. 1 is a schematic diagram showing a configuration example of a network system including a server as an information processing apparatus according to an embodiment of the present disclosure. A network system 100 includes a network 10, an imaging apparatus 200 connectable to the network 10, a server 300 as an information processing apparatus according to the embodiment of the present disclosure, and a server 400 as another information processing apparatus. It should be noted that the number of servers as other information processing apparatuses is not limited.

The network 10 is a network using a standard protocol of TCP/IP (Transmission Control Protocol/Internet Protocol) or the like, such as the Internet, WAN (Wide Area Network), WWAN (Wireless WAN), LAN (Local Area Network), WLAN (Wireless LAN), or a home network.

### [Hardware Configuration of Imaging Apparatus]

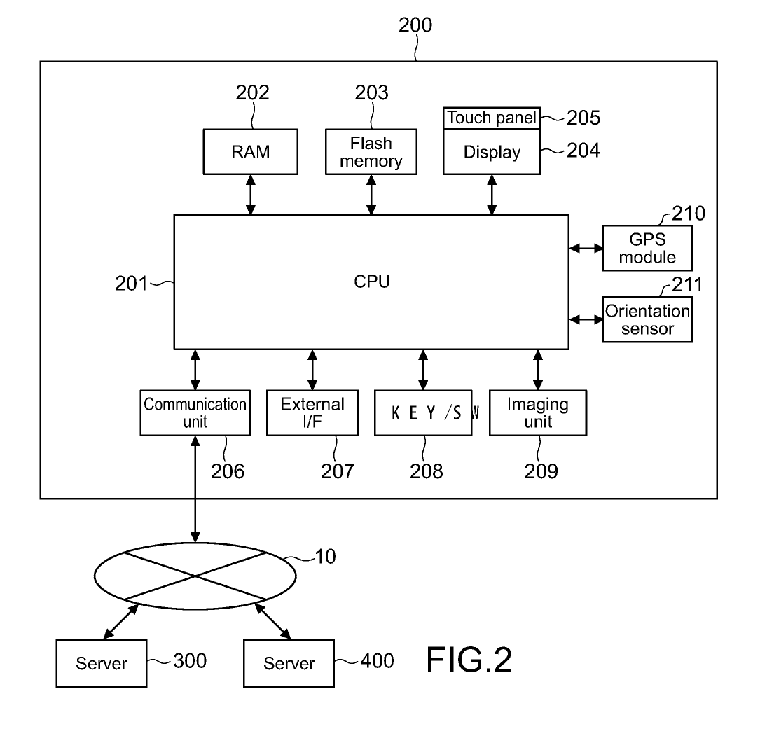

FIG. 2 is a block diagram showing an example of a hardware configuration of the imaging apparatus 200.

The imaging apparatus 200 includes a CPU (Central Processing Unit) 201, a RAM (Random Access Memory) 202, a flash memory 203, a display 204, a touch panel 205, a communication unit 206, an external interface (I/F) 207, and a key/switch unit 208. Further, the imaging apparatus 200 includes an imaging unit 209, a GPS (Global Positioning System) module 210, and an orientation sensor 211.

The CPU 201 exchanges signals with the blocks of the imaging apparatus 200 to perform various computations, and collectively controls processing executed by the imaging apparatus 200, such as imaging processing for images, processing of generating an imaging file including metadata, and the like.

The RAM 202 is used as a work area of the CPU 201 and temporarily stores various types of data processed by the CPU 201, such as captured images and metadata, and programs such as applications.

The flash memory 203 is, for example, a NAND-type flash memory and stores data necessary for various types of processing, content data such as shot images, and various programs such as applications and control programs executed by the CPU 201. Further, when an application is executed, the flash memory 203 reads out various types of data necessary for the execution of the application to the RAM 202.

The various programs described above may be stored in other recording media (not shown) such as memory cards. Further, the imaging apparatus 200 may include an HDD (Hard Disk Drive) or the like as a storage apparatus provided in place of the flash memory 203 or an additional storage apparatus.

The display 204 is an LCD (Liquid Crystal Display), an GELD (Organic Electro-Luminescence Display), or the like. On the display 204, captured images, thumbnail images thereof, or through-the-lens images to be shot are displayed, for example. Further, GUIs (Graphical User Interfaces) for setting shooting conditions or the like, GUIs for using applications or the like, etc. are displayed on the display 204.

As shown in FIG. 2, the display 204 of this embodiment is integrally formed with the touch panel 205. The touch panel 205 detects a touch operation of a user and transmits an input signal to the CPU 201. As the operation system of the touch panel 205, a resistive system or a capacitive system is used, for example. However, other systems such as an electromagnetic induction system, a matrix switch system, a surface acoustic wave system, and an infrared system may be used.

The communication unit 206 is an interface for connecting the imaging apparatus 200 to the network 10 described above such as WAN (WWAN), Ethernet (registered trademark), and LAN (WLAN) in conformity with the respective standards. The communication unit 206 includes a built-in module for the connection to the WWAN, for example, but it may function when other communication device such as a PC card is attached thereto. The communication unit 206 can switch a connection function with respect to WWAN and WLAN in accordance with an operation of the user so that an active or non-active state is set.

The external I/F 207 is an interface for connecting to external equipment based on the standards such as USB (Universal Serial Bus) and HDMI (High-Definition Multimedia Interface). By the external I/F 207, various types of data such as image files can be transmitted and received to and from the external equipment. Further, the external I/F 207 may be an interface for connecting to various memory cards such as memory sticks.

The key/switch unit 208 receives a user's operation made, for example, with use of a power switch or a shortcut key, which is incapable of being input through the touch panel 205 particularly, and transmits an input signal to the CPU 201.

The imaging unit 209 includes an imaging controller, an image pickup device, and an imaging optical system (not shown). As the image pickup device, for example, a CMOS (Complementary Metal Oxide Semiconductor) and CCD (Charge Coupled Device) sensors are used. The imaging optical system forms an image of a subject on an imaging surface of the image pickup device. The imaging controller drives the image pickup device based on an instruction from the CPU 201 and performs signal processing on image signals output from the image pickup device. Further, the imaging controller controls the imaging optical system to set a zoom magnification of an image to be captured.

The data of the captured image is compressed by a compression system such as JPEG (Joint Photographic Experts Group), and then stored in the RAM 202 or the flash memory 203 or transferred to other equipment via the external I/F 207. Further, in this embodiment, metadata (additional information) defined by Exif (Exchangeable Image File Format) is added to image data. In other words, an image file obtained by adding metadata to image data is transmitted to the server 300 via the network 10.

The GPS module 210 is configured to calculate shooting position information based on a GPS signal received by a GPS antenna (not shown) and outputs the calculated shooting position information to the CPU 201. The calculated shooting position information includes various types of data on a shooting position, such as latitude, longitude, and altitude. It should be noted that as a method of acquiring the shooting position information, other methods may be used. For example, based on information of access points through a wireless LAN present in the surroundings, the shooting position information may be derived. Further, altitude information included in the shooting position information may be generated by, for example, providing a barometer (not shown) to the imaging apparatus 200 and measuring an altitude with the barometer.

In addition, for example, the imaging apparatus 200 may be provided with an angular velocity sensor such as gyroscope, an acceleration sensor, or the like (not shown), and the shooting position information may be acquired with the sensors above. For example, there is a case where a GPS signal is difficult to be received in a canyon between high-rise buildings or the like and position information is incapable of being calculated. In such a case, a displacement from a position where position information can be calculated by the GPS module 210 is calculated with an angular velocity sensor or the like. In such a manner, information of a position where a GPS signal is difficult to be received may be acquired.

The orientation sensor 211 is a sensor that determines an orientation on the earth with use of the earth's magnetism, and outputs a determined orientation to the CPU 201. For example, the orientation sensor 211 is a magnetic field sensor including two coils each having an axis, the axes being orthogonal to each other, and an MR element (magnetoresistive element) disposed at the center of the coils. The MR element is an element that senses the earth's magnetism and has a resistance value varied depending on the strength of the magnetism. A resistance change of the MR element is divided into two directional components by the two coils, and the orientation is calculated based on the ratio between the two directional components of the earth's magnetism.

In this embodiment, the orientation in a shooting direction of the imaging apparatus 200 is determined by the orientation sensor 211. The shooting direction is a direction extending from a shooting position (for example, position where the imaging apparatus 200 is located) to a position where a subject within a captured image generated by the imaging unit 209 is located. Specifically, a direction from the shooting position to a subject located at the center of the captured image is calculated as a shooting direction. In other words, a determined imaging direction corresponds to an optical axis direction of the imaging unit 209. It should be noted that as a method of acquiring shooting direction information, other methods may be used. For example, based on the GPS signal described above, the shooting direction information may be acquired. Further, an orientation magnetic needle having a different structure, or the like may be used as an orientation sensor.

As the imaging apparatus 200, various cameras such as a compact digital camera and a digital single-lens reflex camera, mobile phones, smartphones, various types of PDAs (Personal Digital Assistants) having an imaging function, and the like are used.

### [Hardware Configuration of Server]

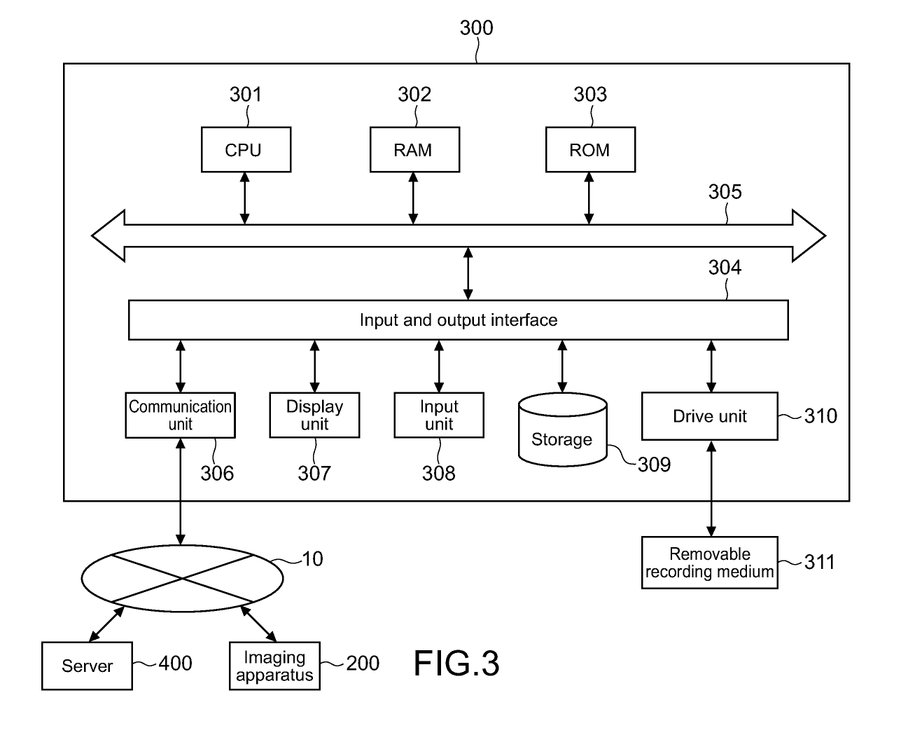

FIG. 3 is a block diagram showing an example of a hardware configuration of the server 300 as an information processing apparatus according to this embodiment. The server 300 according to this embodiment has a hardware configuration of a typical computer such as a PC (Personal Computer).

As shown in FIG. 3, the server 300 includes a CPU 301, a RAM 302, a ROM (Read Only Memory) 303, an input and output interface 304, and a bus 305 for connecting those components to one another.

The CPU 301 accesses the RAM 302 or the like as appropriate and collectively controls the whole blocks of the server 300 while performing various computations. The ROM 303 is a nonvolatile memory in which an OS (Operating System) to be executed by the CPU 301 and firmware including programs, various parameters, and the like are fixedly stored. The RAM 302 is used as a work area or the like of the CPU 301 and temporarily stores the OS, various applications being executed, and various types of data being processed.

A communication unit 306, a display unit 307, an input unit 308, a storage 309, a drive unit 310, and the like are connected to the input and output interface 304. The display unit 307 is a display device using an LCD, an OELD, a CRT (Cathode Ray Tube), or the like. The display unit 307 may be incorporated in the server 300 or may be externally connected to the server 300.

The input unit 308 is a pointing device such as a mouse, a keyboard, a touch panel, or other operation apparatus, for example. In the case where the input unit 308 includes a touch panel, the touch panel may be integrated with the display unit 307.

The storage 309 is, for example, an HDD, a flash memory, or a nonvolatile memory such as other solid-state memory. The storage 309 stores the OS, various applications, and various types of data. In this embodiment, the storage 309 also stores a program such as an application for controlling panoramic image generation processing to be described later. Further, the storage 309 stores, as a database, one or more image data items to be retrieved in the panoramic image generation processing.

The drive unit 310 is a device capable of driving a removable recording medium 311 such as an optical recording medium, a floppy (registered trademark) disk, a magnetic recording tape, or a flash memory. In contrast to this, the storage 309 is used as a built-in device of the server 300 that mainly drives non-removable recording media in many cases. Application programs or the like may be read from the removable recording medium 311 by the drive unit 310.

The communication unit 306 is a modem, a router, or other communication equipment that is capable of connecting to the network 10 and is used for communicating with other devices. The communication unit 306 may perform wired or wireless communication. The communication unit 306 may be used separately from the server 300.

Through the communication unit 306, the server 300 can be connected to the imaging apparatus 200 and another server 400 via the network 10. In other words, the communication unit 306 functions as a connection unit according to this embodiment.

The server 400 also has substantially the same configuration as the hardware configuration as shown in FIG. 3. In this embodiment, one or more image data items are stored in the storages of the servers 300 and 400 as a database. Those image data items are transmitted from a user operating the imaging apparatus 200 via the network 10 and stored in the storages, for example. Alternatively, the image data items may be transmitted from an unspecified number of users to the server 300 or 400 via the network 10 and accumulated in the storage thereof.

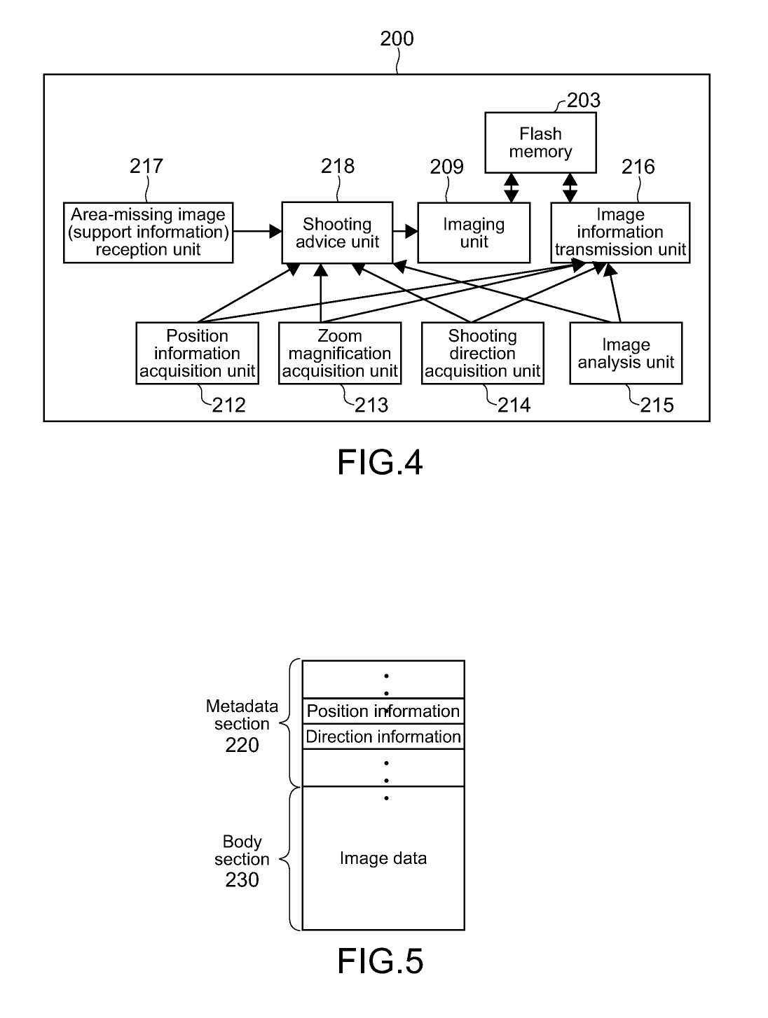

FIG. 4 is a block diagram showing a functional configuration example of the imaging apparatus 200 according to this embodiment. The functional blocks shown in FIG. 4 are implemented by cooperation of software resources such as the programs stored in the flash memory 203 and the like shown in FIG. 2 and hardware resources such as the CPU 201.

A position information acquisition unit 212, a zoom magnification acquisition unit 213, and a shooting direction acquisition unit 214 shown in FIG. 4 acquire information items of a shooting position, a zoom magnification, and a shooting direction that are obtained when an image is captured by the imaging apparatus 200, as metadata of the captured image. Further, an image analysis unit 215 acquires image information including resolution information, color information, magnification information, and the like of the captured image and camera characteristic information items on a focal length, an aperture value, a shutter speed, and the like. In addition, information items on date and time, weather, and the like are acquired as metadata. It should be noted that weather information or the like is acquired from a server or the like that provides weather information via the network 10 based on date and time information, for example.

The zoom magnification described above is calculated based on, for example, a ratio of a focal length at a time of photo shooting to a focal length of 50 mm (35 mm format) of a normal lens. For example, when an image is shot in a focal length of 100 mm, a zoom magnification is doubled. However, a method of calculating a zoom magnification is not limited to the above method. For example, a zoom magnification may be calculated later based on the focal length information acquired by the image analysis unit 215. When a digital still camera or the like is used for performing photo shooting, a focal length is recorded in many cases. With use of this focal length, the zoom magnification information may be acquired.

The image data obtained by the imaging unit 209 is stored in the flash memory 203 and output to the image information transmission unit 216. Information items of a shooting position, a zoom magnification, and a shooting direction and other metadata are also output to the image information transmission unit 216. Then, an image file obtained by adding metadata to each image data item is generated and transmitted to the server 300 via the network 10.

FIG. 5 is a diagram schematically showing a configuration example of the image file transmitted by the image information transmission unit 216. The image file includes a metadata section 220 and a body section 230. The metadata section 220 corresponds to an area called header, for example. In this embodiment, metadata such as position information and direction information is stored in the metadata section 220. In the body section 230, image data generated from an image signal in accordance with a timing at which a release execution instruction is generated is stored.

An area-missing image (support information) reception unit 217 shown in FIG. 4 receives an area-missing image or support information, which will be described later, from the server 300 via the network 10. A shooting advice unit 218 displays, on the display 204, a GUI or the like for capturing an image necessary for generating a panoramic image based on the received area-missing image or support information. This processing will be described later.

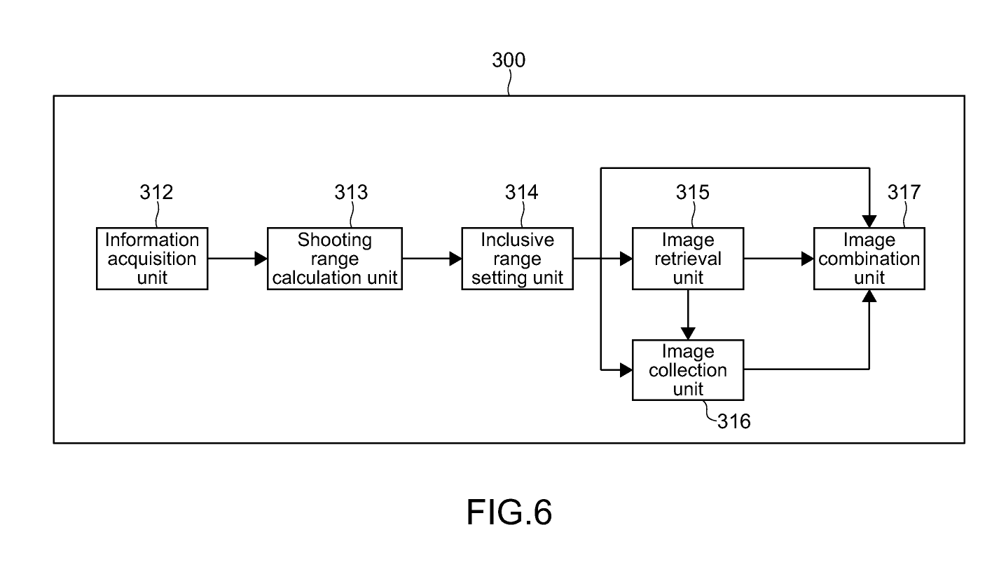

FIG. 6 is a block diagram showing a functional configuration example of the server 300 as the information processing apparatus according to this embodiment. The functional blocks shown in FIG. 6 are implemented by cooperation of software resources such as the programs stored in the storage 309 and the like shown in FIG. 3 and hardware resources such as the CPU 301.

The server 300 includes an information acquisition unit 312, a shooting range calculation unit 313, an inclusive range setting unit 314, an image retrieval unit 315, an image collection unit 316, and an image combination unit 317.

The information acquisition unit 312 acquires metadata such as image information, shooting position information, shooting direction information, and zoom magnification information from the image file transmitted from the imaging apparatus 200. The shooting range calculation unit 313 calculates a shooting range that is a display range of the input image based on the shooting position information and the like. The inclusive range setting unit 314 sets an inclusive range including at least a part of the calculated shooting range.

The image retrieval unit 315 retrieves images to be combined, which are used for generating a panoramic image serving as a combined image obtained based on captured images, from one or more image data items stored in the storage 309 and the like of the server 300. Here, the images to be combined include images combined so as to generate a panoramic image, and combination candidate images to be candidates for the images to be combined.

The image collection unit 316 retrieves images to be combined from one or more image data items stored in another server 400 via the network 10. In this embodiment, the image retrieval unit 315 and the image collection unit 316 function as a retrieval unit for retrieving images to be combined that are associated with the input captured image.

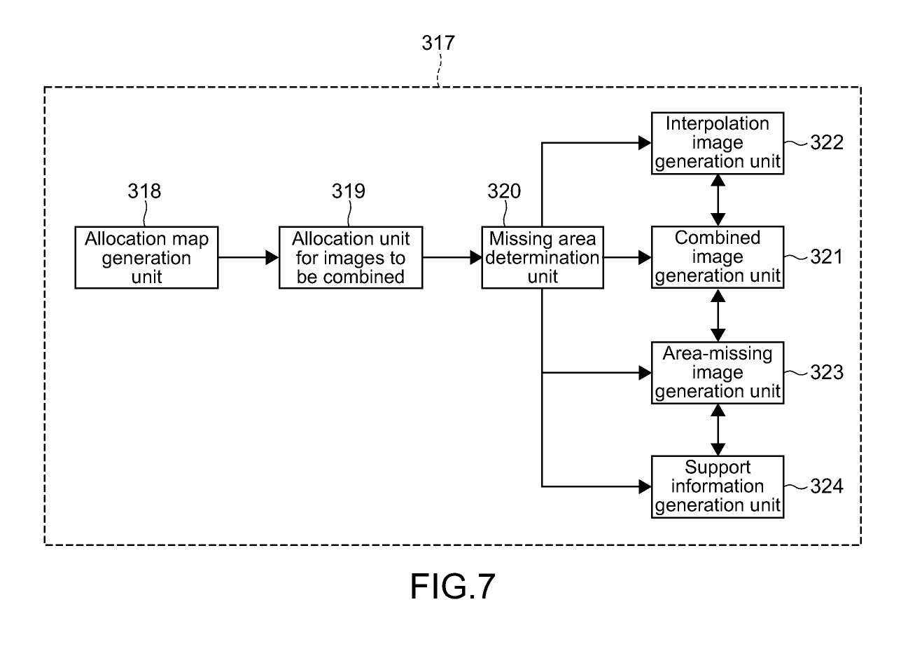

FIG. 7 is a block diagram showing a configuration example of the image combination unit 317 shown in FIG. 6. The image combination unit 317 includes an allocation map generation unit 318, an allocation unit 319 for images to be combined, a missing area determination unit 320, a combined image generation unit 321, an interpolation image generation unit 322, an area-missing image generation unit 323, and a support information generation unit 324.

The allocation map generation unit 318 generates an allocation map for allocating an image to be combined to an inclusive range. The allocation unit 319 for images to be combined arranges the images to be combined, which have been retrieved, in the inclusive range based on the generated allocation map. The allocation unit 319 for images to be combined functions as an arrangement unit according to this embodiment.

The missing area determination unit 320 determines an area within the inclusive range, in which an image to be combined is not arranged, as an image-missing area. The interpolation image generation unit 322 generates an interpolation image for interpolating an image-missing area.

The combined image generation unit 321 combines the arranged images to be combined or interpolation images to thereby generate a panoramic image as a combined image.

The area-missing image generation unit 323 and the support information generation unit 324 generate information on the determined image-missing area. The area-missing image generation unit 323 generates an area-missing image in which the image-missing area is visualized. The support information generation unit 324 generates support information that is used for capturing an image allocated to the determined image-missing area and includes at least information of a shooting position and a shooting direction. The area-missing image data and support information are output from the communication unit 306 of the server 300 to the imaging apparatus 200 via the network 10. The area-missing image generation unit 323, the support information generation unit 324, and the communication unit 306 implement a notification unit according to this embodiment.

### [Operation of Server]

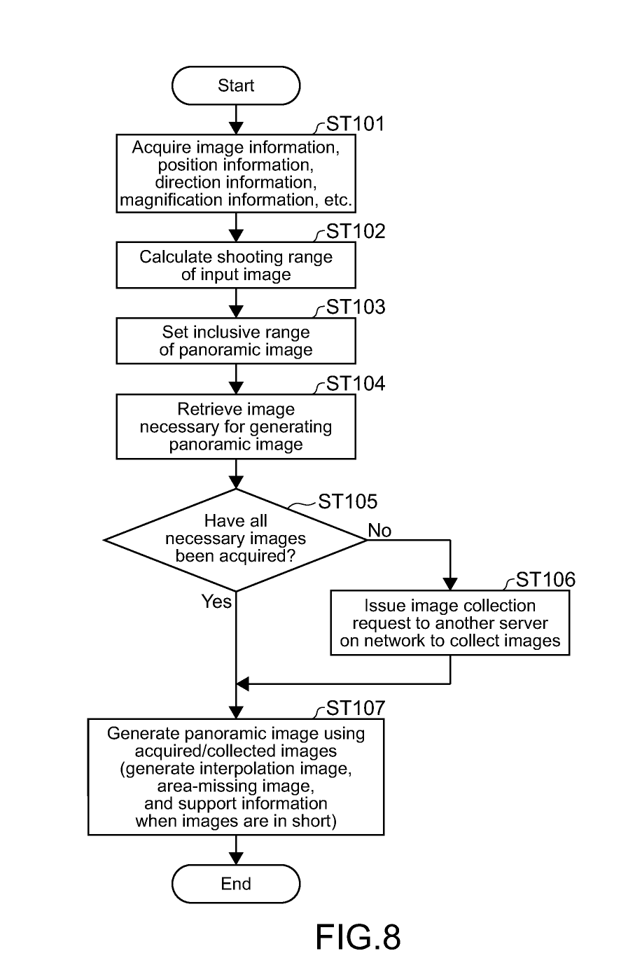

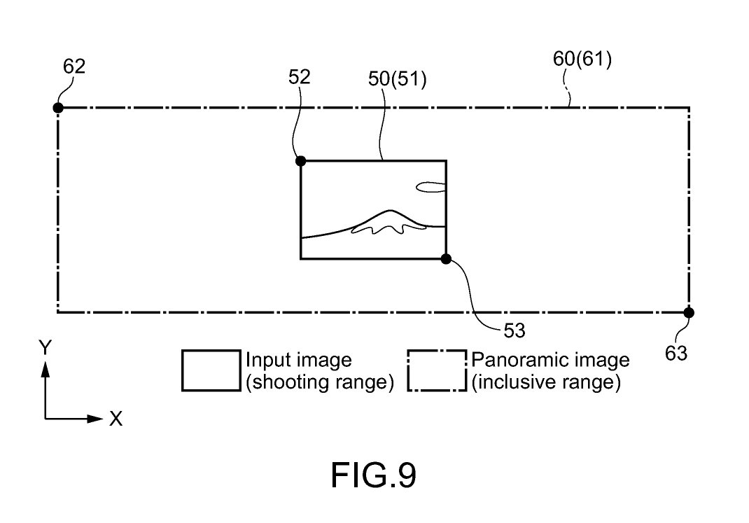

The operation of the server 300 as the information processing apparatus according to this embodiment will be described. FIG. 8 is a flowchart showing the operation of the server 300. FIG. 9 is a diagram for describing the steps shown in FIG. 8.

The image file transmitted from the communication unit 206 of the imaging apparatus 200 via the network 10 is received by the communication unit 306 of the server 300. Accordingly, an image 50 captured by the imaging apparatus 200 is input to the server 300.

Metadata such as image information, position information, direction information, and magnification information is acquired by the information acquisition unit 312 shown in FIG. 6 (Step 101). A shooting range 51 of the captured image 50 is calculated based on the metadata by the shooting range calculation unit 313 (Step 102).

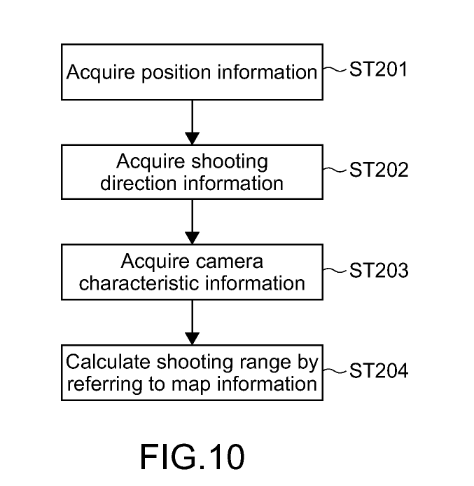

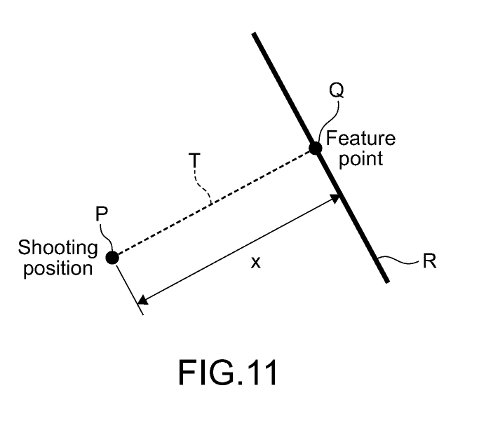

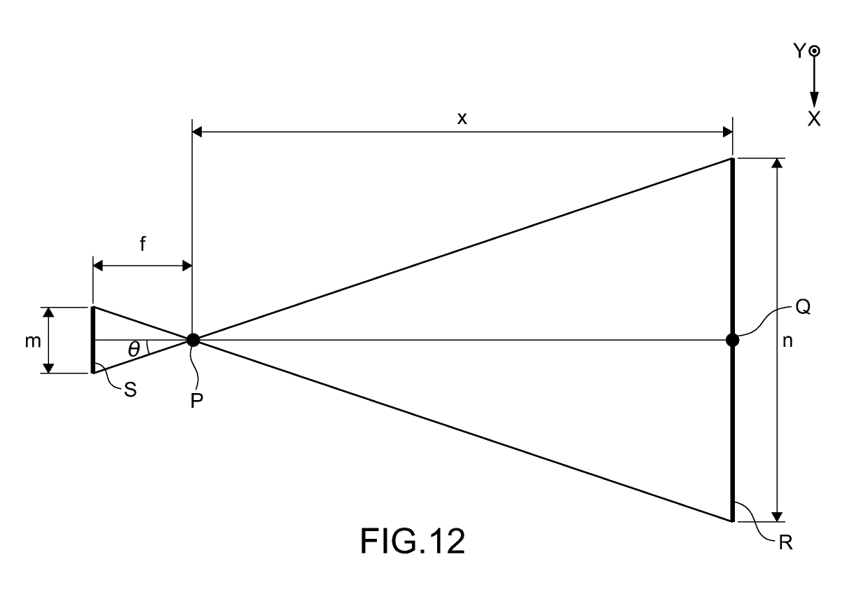

FIG. 10 is a flowchart showing an example of calculation processing for the shooting range 51 according to this embodiment. FIGS. 11 and 12 are diagrams for describing the calculation processing for the shooting range 51.

In this embodiment, latitude and longitude information as shooting position information, shooting direction information, and focal length information included in the camera characteristic information are used for the calculation processing for the shooting range 51 (Steps 201 to 203).

Based on the latitude and longitude information, a shooting position P shown in FIGS. 11 and 12 is determined. Although the shooting position P is a position where the imaging apparatus 200 is located, a position of the lens of the imaging optical system may be calculated in detail by correcting the position information. Further, a position within a predetermined range from the position of the imaging apparatus 200 (or position of the lens) may be determined as the shooting position P.

Based on the shooting direction information, a shooting direction of the imaging apparatus 200, that is, to which direction from the shooting position P the photo shooting has been performed, is determined. In this embodiment, map information is stored in the storage 309 of the server 300 or the like, and the shooting direction information is represented by north, south, east, and west.

Based on the shooting position information, shooting direction information, and map information, a subject as a shooting target is determined. For example, the map information is referred to so that a building, a natural object, or the like that is present from the shooting position P toward the shooting direction is determined. Then, the center point of the determined subject is set as a feature point Q. It should be noted that instead of the center point of the subject, the position of a distinctive part (for example, gate etc.) of a building or the like to be a subject may be set as a feature point Q.

In this embodiment, an image of Mt. Fuji is used as the captured image 50. Therefore, a point at the center of Mt. Fuji is determined as the feature point Q.

For example, famous buildings and sightseeing spots such as Mt. Fuji and Tokyo Sky Tree may be set in advance as candidates of the feature point Q. In other words, buildings and the like highly possible to be a subject may be set in advance as candidates, and a subject may be selected therefrom. Alternatively, information on a building, a natural object, or the like that is present from the shooting position P toward the shooting direction may be transmitted to the imaging apparatus 200 via the network 10 so that a subject may be set by a user. Accordingly, for example, in the case where a plurality of buildings or the like are determined as candidates of a subject based on the map information, an adequate subject is set.

As shown in FIGS. 11 and 12, a reference plane R with the feature point Q as a reference is set. The reference plane R is set to be perpendicular to the shooting direction. The reference plane R is set with the position information (latitude and longitude) of the feature point Q as a reference.

As shown in FIG. 12, on the set reference plane R, the shooting range 51 of the captured image 50 is calculated. In FIG. 12, a size n of the shooting range 51 in a horizontal direction of the captured image 50 (X direction shown in FIG. 9) is shown.

The size n of the shooting range is calculated using information items on a size m of an imaging surface S in the X direction, a focal length f, a shooting position P, the position of a feature point Q, and a distance x between the shooting position P and the position of the feature point Q. The information on the size m of the imaging surface S is acquired from the camera characteristic information together with the information on the focal length f. The distance x is calculated based on the latitude and longitude of each of the shooting position P and the feature point Q. It should be noted that in this embodiment, the focal length f is converted in terms of a focal length in the case of using a 35-mm film.

With use of those parameters, the following expression for an angle θ shown in FIG. 12 is established.

$$tan θ = \frac{\frac{m}{2}}{f} \qquad [ Expression 1 ]$$

Based on the result, the size n of the shooting range 51 is represented by the following expression.

Size n of shooting range=Distance x*tan θ*2 [Expression 2]

The size of the shooting range 51 of the captured image 50 in the vertical direction (Y direction shown in FIG. 9) is calculated similarly. For example, there is a case where the information on the size of the imaging surface S in the vertical direction is difficult to be obtained. In such a case, as the size of the shooting range 51 in the vertical direction, the size substantially the same as or slightly larger than the size n of the shooting range in the horizontal direction may be set.

In such a manner, in this embodiment, a shooting range of the captured image is calculated by referring to the map information (Step 204).

As shown in Step 103 of FIG. 8, an inclusive range of a panoramic image 60 is set by the inclusive range setting unit 314. As shown in FIG. 9, the inclusive range 61 corresponds to a display range of the panoramic image 60 to be generated. It should be noted that although FIG. 9 is a diagram obtained before the panoramic image 60 is generated, the panoramic image 60 is shown for easy understanding of the description.

As shown in FIG. 9, in this embodiment, the inclusive range 61 is set such that the captured image 50 is located at the center thereof. Based on the size of the shooting range 51 of the captured image 50 that is calculated in Step 102 of FIG. 8, latitude and longitude information of a point 52 of the captured image 50 at the upper left and a point 53 thereof at the lower right is first calculated.

A ratio of a resolution (number of pixels) of the captured image 50 to a resolution (number of pixels) of an assumed panoramic image 60 is calculated. For example, in this embodiment, the size of the captured image 50 is set to a UXGA (UltraXGA) size of 1,600×1,200 (pixel). The size of the panoramic image 60 to be generated is set to 6,700×2,500 (pixel). However, the size of both the images 50 and 60 can be set as appropriate in the present disclosure.

Based on the ratio of the size of the captured image 50 to the size of the panoramic image 60, latitude and longitude information of a point 62 of the inclusive range 61 at the upper left and a point 63 thereof at the lower right is calculated. The latitude and longitude information of the points 62 and 63 is calculated based on the latitude and longitude information of the points 52 and 53 of the captured image 50. Accordingly, the inclusive range 61 as a display range of the panoramic image 60 is set.

The inclusive range 61 may be set such that the captured image 50 is not located at the center thereof. In other words, a relative positional relationship between the captured image 50 and the set inclusive range 61 can be set as appropriate. Further, in this embodiment, although the inclusive range 61 is set so as to include the entire shooting range 51, the inclusive range 61 may be set so as to include not the entire shooting range 51 but at least a part thereof. Alternatively, for example, information items on the shooting range 51 and the inclusive range 61 are transmitted to the imaging apparatus 200 via the network 10. Then, GUIs indicating the shooting range 51 and the inclusive range 61 may be displayed so that the position or the like of the inclusive range 61 may be set by a user.

In this embodiment, the latitude and longitude information of the points of the captured image 50 and the inclusive range 61 at the upper left thereof (point 52, point 62) and the points at the lower right thereof (point 53, point 63) are calculated. However, the information is not limited to that of those points. Latitude and longitude information of a middle point of each of four sides of the captured image 50 and the inclusive range 61 may be calculated, for example.

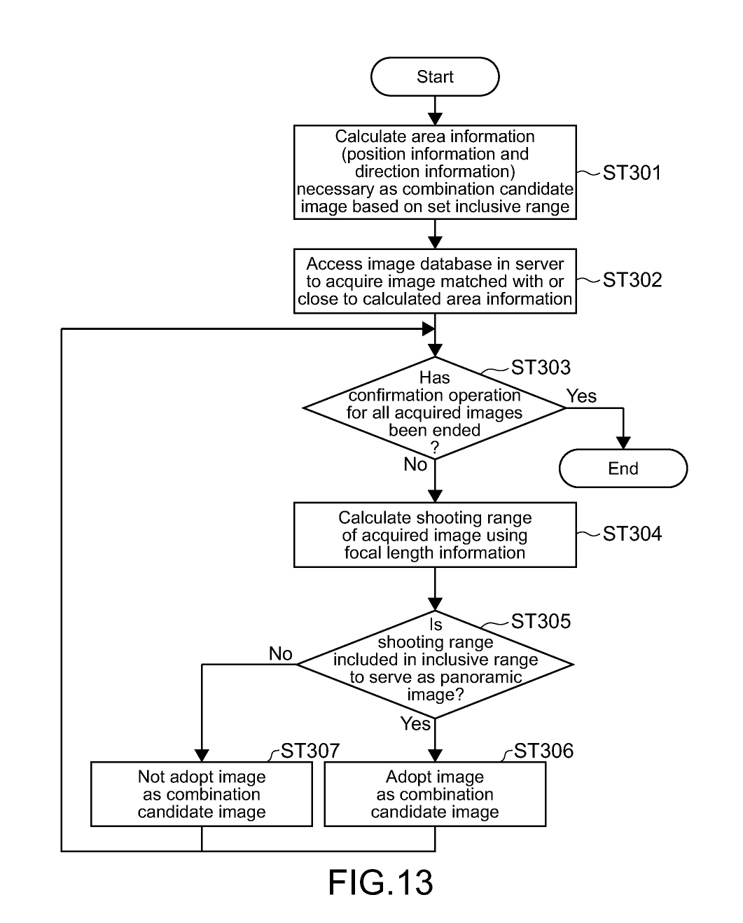

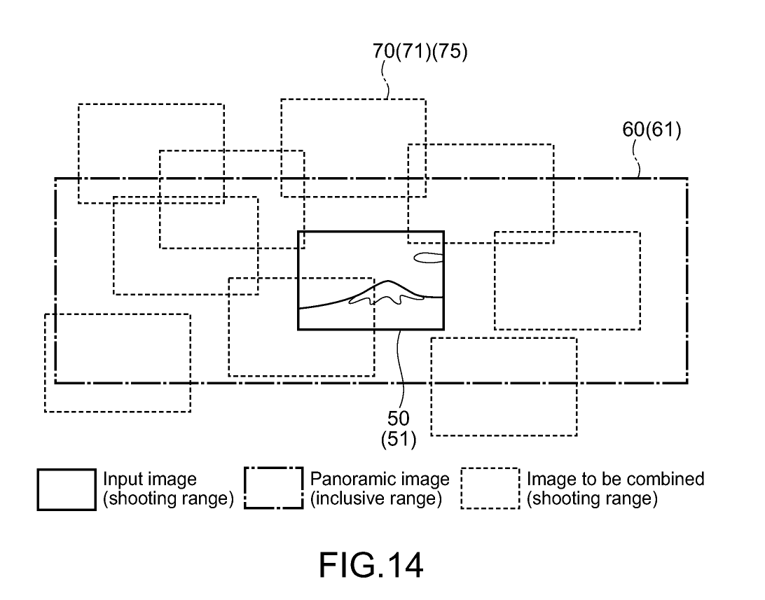

In Step 104 of FIG. 8, the image retrieval unit 315 retrieves an image to be combined, which is used for generating the panoramic image 60. FIG. 13 is a flowchart showing an example of image retrieval processing by the image retrieval unit 315. FIG. 14 is a diagram for describing the image retrieval processing.

As an image 70 to be combined, an image in which at least a part of a shooting range 71 thereof is included in the inclusive range 61 is retrieved. To retrieve such an image, in Step 301 shown in FIG. 13, area information as a condition for being selected as an image 70 to be combined is first calculated. In this embodiment, the shooting position information and shooting direction information are used as the area information.

The area information is calculated based on the inclusive range 61 set by the inclusive range setting unit 314. For example, as the shooting position information, position information indicating a position substantially the same as the shooting position P of the captured image 50 is calculated. Alternatively, position information of a position in a predetermined range from the shooting position P of the captured image 50 may be calculated. Alternatively, position information indicating a position in the vicinity of a line T connecting the position of the feature point Q (Mt. Fuji) and the shooting position P shown in FIG. 11 may be calculated.

The shooting direction information calculated as the area information is calculated based on the latitude and longitude information calculated for the shooting position P of the captured image 50, the point 62 of the inclusive range 61 at the upper left, and the point 63 thereof at the lower right. In addition, a setting method for the area information (position information and direction information), which is used for acquiring an image to be combined whose area within the inclusive range 61 is probably captured, can be set as appropriate.

From the image database stored in the storage 309 and the like of the server 300, an image having position information and direction information matched with or close to the area information described above is acquired (Step 302). Then, from one or more obtained images, a combination candidate image 75 is selected in the processing in Step 303 and the subsequent steps.

In Step 303, it is determined whether a confirmation operation as to whether the obtained image can be adopted as a combination candidate image 75 has been performed for all the images. When the confirmation operation is ended (Yes in Step 303), the image retrieval processing is ended.

In the case where the confirmation operation has been not ended (No in Step 303), a shooting range 71 of an image that has not been subjected to the confirmation is calculated (Step 304). The shooting range 71 may be calculated in the same manner as the calculation processing for the shooting range 51 of the captured image 50, for example.

Whether the calculated shooting range 71 is included in the inclusive range 61 that is to be a panoramic image 60 is determined (Step 305). In the case where the shooting range 71 is included in the inclusive range 61 (Yes in Step 305), the image is adopted as a combination candidate image 75 (Step 306). In the case where the shooting range 71 is not included in the inclusive range 61 (No in Step 305), the image is not adopted as a combination candidate image 75 (Step 307).

In Step 305, a threshold value indicating to what extent the shooting range 71 of a retrieved image is included in the inclusive range 61 may be set so that a combination candidate image 75 may be selected based on the threshold value. The threshold value may be set for the number of pixels of the area included in the inclusive range 61, for example. For example, the number of pixels equal to 10% or less of the number of pixels of the entire panoramic image 60 may be set as a threshold value.

In Step 105 of FIG. 8, with the combination candidate images 75 retrieved by the image retrieval unit 315, whether all images 70 to be combined necessary for generating a panoramic image 60 have been acquired is determined. For example, in the case where the entire inclusive range 61 is covered with the shooting ranges 71 of the retrieved combination candidate images 75, it is determined that all images 70 to be combined necessary for generating a panoramic image 60 have been acquired.

This determination is performed when the area information generated in Step 301 of FIG. 13 and the position information and direction information of the retrieved combination candidate images 75 are referred to. Alternatively, the latitude and longitude information of the points at the upper left and lower right of each combination candidate image 75 is calculated. Then, the determination may be performed based on the latitude and longitude information.

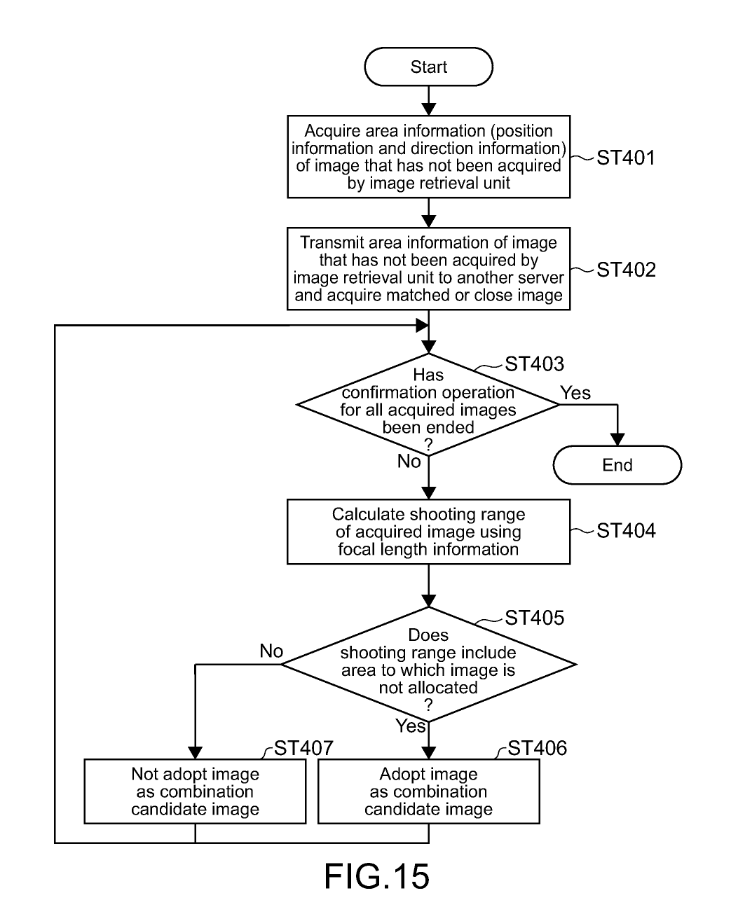

When it is determined that all the images 70 to be combined have not been acquired (No in Step 105), images 70 to be combined are collected by the image collection unit 316 (Step 106). FIG. 15 is a flowchart showing an example of image collection processing by the image collection unit 316.

Area information of an image that has not been acquired by the image retrieval unit 315 is acquired (Step 401). In other words, area information of images necessary for areas that do not cover the inclusive range 61 is acquired. For example, the area information may be calculated in substantially the same manner as the calculation processing for the area information of images 70 to be combined necessary to the inclusive range 61 (Step 301 of FIG. 13).

The calculated area information is transmitted to another server 400 via the network 10. Then, in the server 400, an image having position information and direction information matched with or close to the area information is acquired from the image database stored in a storage and the like. The acquired image is transmitted to the server 300 via the network 10. Accordingly, the server 300 acquires an image associated with the captured image 50 from the server 400 via the network 10 (Step 402).

In Steps 403 to 407, the same processing as that performed in Steps 303 to 307 shown in FIG. 13 is performed, and the combination candidate image 75 is selected.

In Step 107 shown in FIG. 8, the panoramic image is generated by the image combination unit 317. The panoramic image 60 is obtained by combining images 70 to be combined with one another, which have been retrieved by the image retrieval unit 315 or collected by the image collection unit 316. Further, an interpolation image, an area-missing image, and support information are generated by the image combination unit 317.

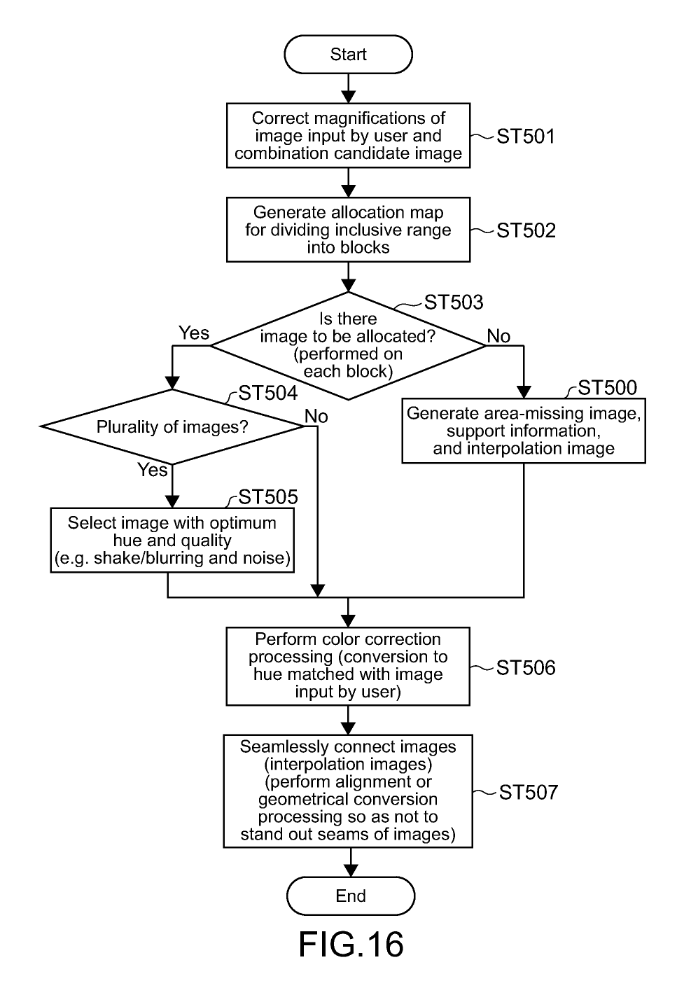

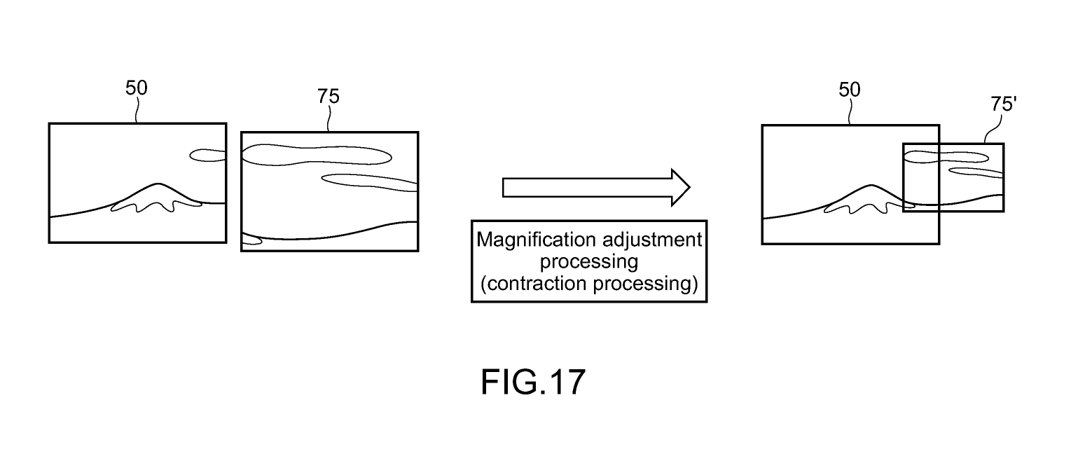

FIG. 16 is a flowchart showing the panoramic image generation processing and generation processing for interpolation images or the like performed by the image combination unit 317. FIGS. 17 to 23 are diagrams for describing the steps shown in FIG. 16.

The magnification of the captured image 50 transmitted from the imaging apparatus 200 and that of the combination candidate image 75 are corrected (Step 501). This processing is performed so as to connect the captured image 50 and the combination candidate image 75 to each other to thereby generate a panoramic image 60. Typically, the magnification of the combination candidate image 75 is adjusted to that of the captured image 50.

FIG. 17 is a diagram for describing magnification correction processing. As shown in FIG. 17, for example, assuming that a high-magnification image shot by a telescope is retrieved as a combination candidate image 75, the captured image 50 and the combination candidate image 75 have different area proportions per unit area. The magnifications of the images 50 and 75 are each corrected so that the area proportions per unit area can be the same.

In the case as shown in FIG. 17, contraction processing is performed on the combination candidate image 75 (see an image 75′ to be combined). Accordingly, the area proportion per unit area is substantially equal to that of the captured image 50. In the case where the magnification of the combination candidate image 75 is lower than that of the captured image 50, enlargement processing is performed on the combination candidate image 75. In this case, the resolution (number of pixels) of the enlarged combination candidate image 75 may be converted to a high resolution.

By the allocation map generation unit 318 shown in FIG. 7, an allocation map for allocating the combination candidate image 75 to the inclusive range 61 is generated (Step 502). The allocation map is a virtual canvas in which the combination candidate image 75 is arranged.

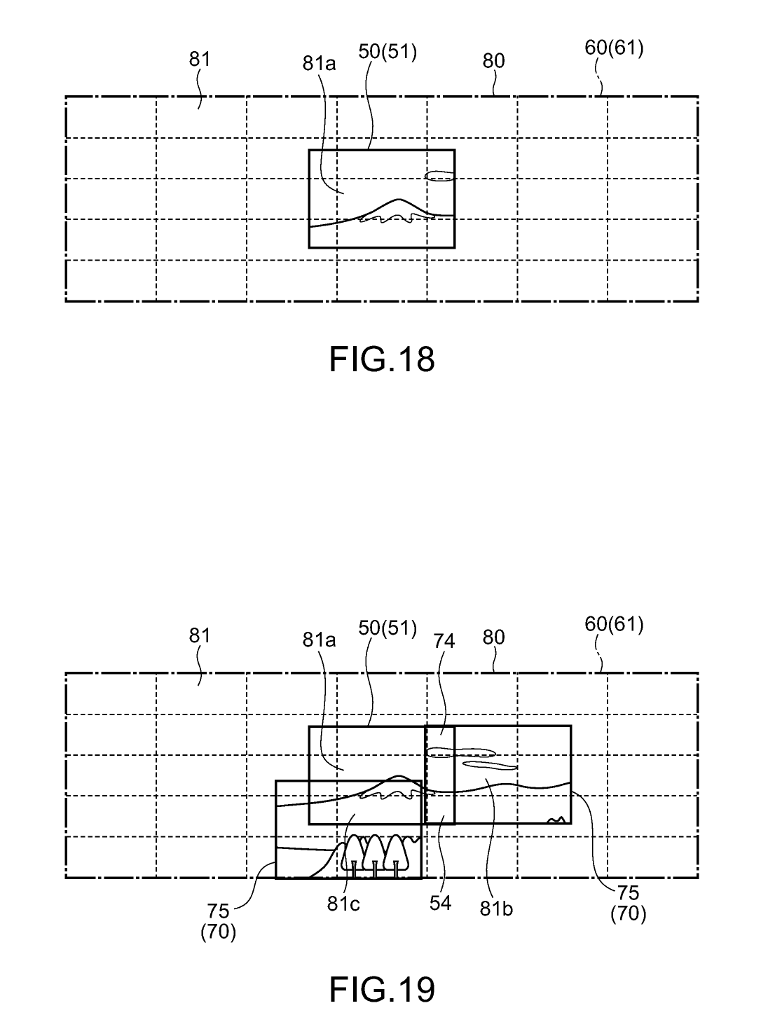

FIG. 18 is a schematic diagram showing an allocation map 80 according to this embodiment. In the allocation map 80, the inclusive range 61 is divided into blocks (arrangement areas) 81 having a predetermined size. In this embodiment, the inclusive range 61 is divided into 35 blocks 81 of vertical five blocks by horizontal seven blocks. As shown in FIG. 18, the captured image 50 is arranged at the center block 81a.

The allocation unit 319 for images to be combined allocates the combination candidate images 75 to the respective blocks 81 (Step 503). FIG. 19 is a diagram for describing allocation processing for the combination candidate images 75.

In this embodiment, the combination candidate image 75 is first allocated to a block 81 adjacent to the center block 81a of the allocation map 80. For example, as shown in FIG. 19, a combination candidate image 75 to be allocated to a block 81b located at the right side of the center block 81a is selected. For example, based on the position information and direction information of the captured image 50 and the size of the block 81, the area information (position information and direction information) as a condition for arrangement in the block 81b is calculated. A combination candidate image 75 having the position information and direction information that is matched with or close to the calculated area information is selected.

Next, the captured image 50 and the selected combination candidate image 75 are subjected to matching processing. As shown in FIG. 19, targets of the matching processing are a right end area 54 of the captured image 50 and a left end area 74 of the selected combination candidate image 75.

In this embodiment, in the right end area 54 and the left end area 74, luminance gradient information of the respective areas is calculated and a local feature amount referred to as SIFT (Scale Invariant Feature Transform) is calculated based on the gradient information. With use of the local feature amount, the matching processing is performed and a positional relationship between the areas 54 and 74 and a degree of matching therebetween are determined. For example, in the case where a predetermined threshold value is set and the result of matching between the areas 54 and 74 takes the threshold value or larger, the selected combination candidate image 75 is selected again as an image 70 to be combined, which is actually used for combination. Then, the image 70 to be combined is arranged at a position where the areas 54 and 74 are best matched.

It should be noted that in the matching processing for the captured image 50 and the combination candidate image 75, any method may be used. In the case where a local feature amount is used, a method other than the SIFT described above may be used. Further, matching processing in which a local feature amount is not used may be used. For example, matching processing may be performed by calculating a correlation coefficient of each luminance value while relatively moving the areas 54 and 74.

In FIG. 19, an image 70 to be combined that is arranged in a block 81c located below the center block 81a is also shown. In this case, the matching processing is performed on a lower end area of the captured image 50 and an upper end area of the combination candidate image 75. Hereinafter, the allocation processing for the image 70 to be combined is performed on blocks 81 adjacent to the block 81b on the right side of the center block 81a and the block 81c below the center block 81a.

In Step 504 of FIG. 16, it is determined whether a plurality of combination candidate images 75 to be allocated to a predetermined block 81 exist. For example, it is assumed that a plurality of images having a predetermined threshold value or larger as a result of the matching with the captured image 50 exist for the block 81b on the right side of the center block 81a. In this case, the processing proceeds to Step 505, and an optimum image is selected from the combination candidate images 75 and then arranged as an image 70 to be combined.

For example, based on the information of luminance values, an image 70 to be combined, which has a hue closest to that of the captured image 50, is arranged. The hue of the captured image 50 differs due to hours, season, weather, and the like when the captured image 50 is obtained, even when images of the same subject are shot from the same position. Therefore, by the arrangement of the image 70 to be combined that has a close hue, a high-quality panoramic image 60 is generated. An optimum image 70 to be combined may be selected based on the metadata such as a date and time of photo shooting, season, and weather that is attached to each image. Further, for example, high-quality images such as an image without shakes or blurring and an image without noises may be selected as the images 70 to be combined. Accordingly, a high-quality panoramic image 60 is generated.

In Step 503, the missing area determination unit 320 determines an area within the inclusive range 61 in which the image 70 to be combined is not arranged, as an image-missing area. For example, in the case where a combination candidate image 75 having information matched with or close to area information on a block 81 of the allocation map 80 does not exist, the block 81 may be determined as an image-missing area. Alternatively, as a result of the matching processing, a block 81 in which an image 70 to be combined is not arranged may be determined as an image-missing area. By the way, for example, there is a case where even when an image 70 to be combined is arranged in each block 81, an area where an image 70 to be combined is not arranged may be generated depending on a position of each image 70 to be combined. Thus, such an area may be determined as an image-missing area.

When the processing of allocating the combination candidate image 75 to each block 81 is performed, color correction processing is performed on the arranged image 70 to be combined (Step 506). Accordingly, for example, based on the hue of the captured image 50, the hue of the entire panoramic image 60 is adjusted, with the result that a high-quality panoramic image 60 is generated.

In Step 507, the captured image 50 and the images 70 to be combined, arranged in the respective blocks 81, are connected by stitching processing. For example, alignment processing or geometrical conversion processing is performed as appropriate so as not to stand out boundaries between the captured image 50 and the images 70 to be combined. As such stitching processing, processing using the feature amount described above, processing using a correlation coefficient, and any other processing may be performed.

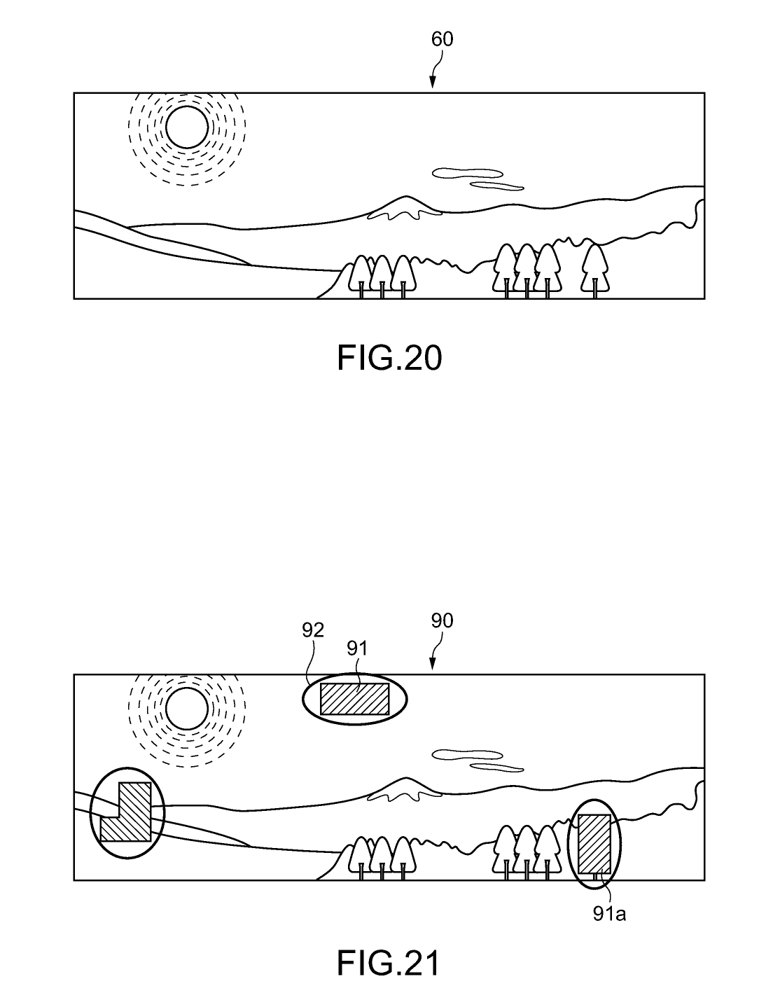

In the case where the entire inclusive range 61 is covered with the images 70 to be combined, which have been arranged to the respective blocks 81, that is, the case where it is determined that image-missing areas do not exist, a high-quality panoramic image 60 as shown in FIG. 20 is generated.

In the case where the missing area determination unit 320 determines that the image-missing area exists, an area-missing image, support information, and an interpolation image are generated by the area-missing image generation unit 323, the support information generation unit 324, and the interpolation image generation unit 322 shown in FIG. 7, respectively (Step 500).

FIG. 21 is a diagram schematically showing an area-missing image. In an area-missing image 90 according to this embodiment, image-missing areas 91 are colored so as to emphasize the areas 91. Further, as emphasis images 92 that emphasize the image-missing areas 91, ellipses enclosing the areas 91 are displayed. As the color for emphasizing the image-missing areas 91 and as the emphasis images 92, any color and emphasis images 92 may be used. For example, an area-missing image 90 in which the image-missing area 91 emits light may be generated. Alternatively, a text-like image, a mark, or the like may be displayed as the emphasis image 92 in the vicinity of the image-missing area 91.

As the area-missing image 90, for example, an image in which the images 70 to be combined that are arranged outside the image-missing area 91 are connected with high accuracy by the stitching processing may be generated. In other words, a high-quality area-missing image 90 having size and resolution substantially the same as those of the panoramic image 60 shown in FIG. 20 may be generated.

Alternatively, as the area-missing image 90, an image having a lower resolution than that of the panoramic image 60 or a thumbnail image may be generated. Further, an image to which the stitching processing is not subjected and in which an image 70 to be combined is arranged to overlap another image 70 to be combined may be generated. In other words, as long as the position of the image-missing area 91 can be recognized by a user, an area having a lower accuracy than that of the panoramic image 60 may be generated as an area-missing image 90. Accordingly, loads on the processing resources such as the CPU 301 and the RAM 302 are reduced and a processing speed can be improved at a certain level.

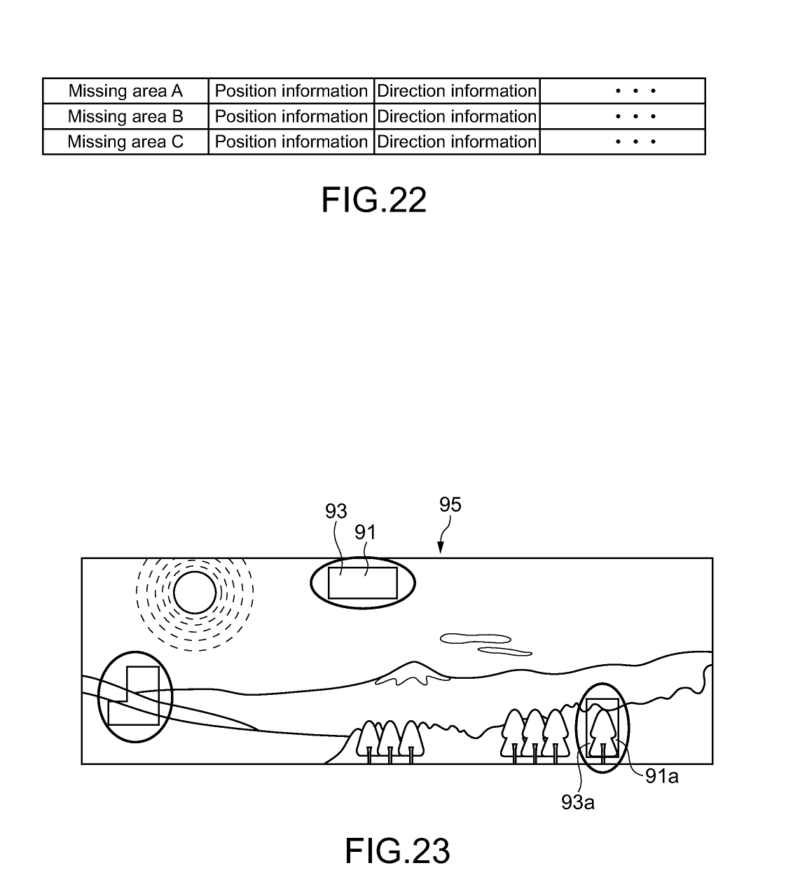

FIG. 22 is a table schematically showing an example of the support information generated by the support information generation unit 324. The support information is information used for capturing an image to be allocated to the image-missing area 91 determined by the missing area determination unit 320.

As shown in FIG. 22, the support information includes at least information on a shooting position and a shooting direction necessary for covering the image-missing area 91. In addition, for example, information on a focal length, a magnification, an altitude, a date and time, weather, and the like may be generated as the support information.

FIG. 23 is a diagram schematically showing an interpolated panoramic image 95 in which the image-missing areas 91 are interpolated by using interpolation images 93. The interpolation images 93 for interpolating the image-missing areas 91 are generated based on, for example, luminance information of an image arranged around each of the image-missing areas 91, shape information of a subject appearing in the image, and the like. Alternatively, the interpolation images 93 are generated based on information of a feature point (Mt. Fuji) of the captured image 50, information on date and time or weather, or the like. Further, the interpolation images 93 may be generated according to a user's instruction given through the touch panel 205 of the imaging apparatus 200.

Here, attention is focused on an image-missing area 91a shown in FIGS. 21 and 23. The image-missing area 91a is interpolated by using an interpolation image 93a in which a tree is displayed. In such a case, when the interpolation image 93 is generated based on an image arranged around the image-missing area 91a, for example, an interpolation image 93 in which no tree is displayed may be generated. Therefore, an interpolation image 93a to which an image of a tree is added according to a user's instruction may be generated, for example. On the other hand, processing of removing unnecessary objects from the interpolation image 93 may be performed according to a user's instruction.

In this embodiment, the images 70 to be combined and the interpolation images 93 are combined in Steps 506 and 507, with the result that an interpolated panoramic image 95 shown in FIG. 23 is generated.

The panoramic image 60, the area-missing image 90, the support information, and the interpolated panoramic image are transmitted to the imaging apparatus 200 via the network 10. For example, the area-missing image 90 is displayed on the display 204 of the imaging apparatus 200. Accordingly, a user can visually recognize the image-missing area 91 and easily grasp an image necessary for completing the panoramic image 60. Then, for example, the user can get close to Mt. Fuji to capture an image for covering the image-missing area 91 with the imaging apparatus 200. Alternatively, the user can retrieve and download an appropriate image via the network 10.

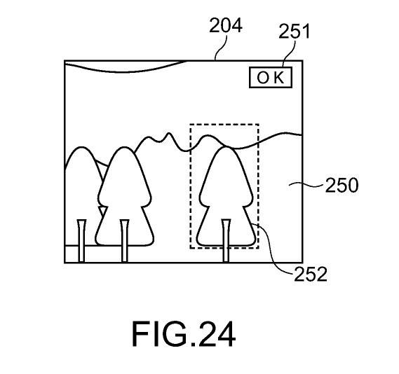

FIG. 24 is a diagram showing an example of a support method using the support information at a time when an image for covering the image-missing area 91 is captured. In FIG. 24, the display 204 of the imaging apparatus 200 and a through-the-lens image 250 displayed on the display 204 are shown. The support processing described herein is executed by the shooting advice unit 218 shown in FIG. 4.

In this embodiment, area information (position information and direction information) of the through-the-lens image 250 displayed on the display 204 is acquired. Then, the acquired area information of the through-the-lens image 250 and the support information (position information and direction information) used for covering the image-missing area 91 are compared to each other.

As a result, in the case where the through-the-lens image 250 can be captured as an image for covering the image-missing area 91, an OK mark is displayed as an imaging instruction mark 251 on the display 204. When the imaging instruction mark 251 is displayed, the user presses an imaging button to execute imaging processing. Accordingly, an image for covering the image-missing area 91 can be easily captured with excellent operability. The imaging instruction mark 251 is not limited to the OK mark, and various GUIs may be displayed as the imaging instruction mark 251. Alternatively, an audio to instruct imaging or the like may be issued.

For example, for a period of time during which the through-the-lens image 250 is being displayed on the display 204, the area information of the through-the-lens image 250 may be constantly acquired and compared with the support information. Alternatively, a mode for confirming whether the through-the-lens image 250 is adequate as an image for covering the image-missing area 91 is selected by the user. At that time, the area information of the through-the-lens image 250 may be acquired and compared with the support information.

Further, as shown in FIG. 24, a GUI indicating an area 252 corresponding to the image-missing area may be displayed on the through-the-lens image 250 displayed on the display 204. Accordingly, the user can capture an image necessary for generating the panoramic image 60 with ease and excellent operability.

As described above, in the server 300 as the information processing apparatus according to this embodiment, the shooting range 51 as a display range of the captured image 50 that has been input from the imaging apparatus 200 via the network 10 is calculated. Further, the inclusive range 61 including at least a part of the shooting range 51 is set. Then, an image associated with the captured image 50 is retrieved as an image 70 to be combined, and arranged in the inclusive range 61. At this time, an area in which the image 70 to be combined is not arranged is determined as the image-missing area 91, and as information related thereto, the user is notified of the area-missing image 90 and the support information via the network 10. Therefore, based on the notification, an image to be allocated to the image-missing area 91 can easily be prepared, and by combining those images, a combined image such as the panoramic image 60 can be generated with excellent operability.

In this embodiment, by the relevance based on the shooting position information and shooting direction information of the captured image 50, the image 70 to be combined is selected and arranged in the inclusive range 61. Accordingly, the panoramic image 60 can be generated with high accuracy.

Further, in the server 300 according to this embodiment, the area-missing image 90 serving as an image obtained by visualizing the image-missing area 91 is generated. Then, the area-missing image 90 is transmitted to the imaging apparatus 200 via the network 10 and the user is notified of this. Accordingly, the image-missing area 91 can be visually recognized.

Further, in the server 300 according to this embodiment, the user is notified of the support information including at least the information on the shooting position and shooting direction, the support information being used for capturing an image to be allocated to the image-missing area 91. Accordingly, an image to be allocated to the image-missing area 91 can easily be captured.

Further, in the server 300 according to this embodiment, the interpolation image 93 that is interpolated in the image-missing area 91 is generated so that the interpolated panoramic image 95 shown in FIG. 23 is generated. Accordingly, even when images used for generating the panoramic image 60 are in short, for example, a large-area image including the captured image 50 can be generated.

Further, the server 300 according to this embodiment is connectable to the server 400 serving as another information processing apparatus storing one or more images via the network 10. Furthermore, the server 300 can retrieve the image 70 to be combined from one or more images stored in the server 400 via the network 10. Accordingly, a more appropriate image as the image 70 to be combined can be retrieved from not only the images stored in the server 300 according to this embodiment but also many images stored in the server 400. As a result, the high-quality panoramic image 60 can be generated.

According to the present disclosure, the high-quality panoramic image 60 can also be generated with excellent operability for a captured image 50 obtained in the past by the captured image 50 being transmitted to the server 300.

### Modified Example

The embodiments according to the present disclosure are variously modified without being limited to the embodiment described above.

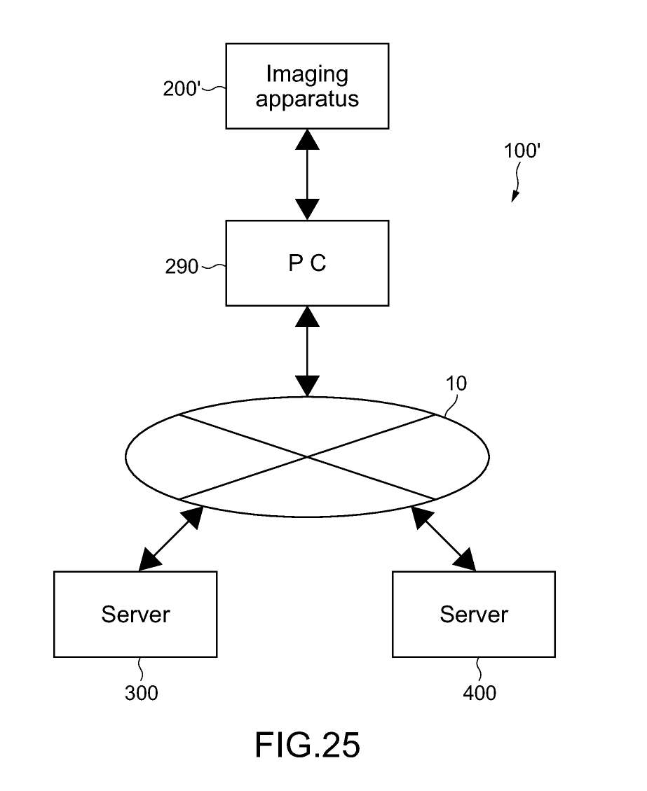

FIG. 25 is a schematic diagram showing a modified example of the network system 100 shown in FIG. 1. In the network system 100 shown in FIG. 1, the captured image 50 is transmitted to the server 300 from the imaging apparatus 200 connectable to the network 10.

However, as in a network system 100′ shown in FIG. 25, a user may connect an imaging apparatus 200′ to a PC 290 and transmit the captured image 50 to the server 300 via the PC 290. Accordingly, a panoramic image with a captured image as a reference can be generated, the captured image 50 being captured by the imaging apparatus 200′ having no network communication functions.

Further, the imaging apparatus 200 shown in FIG. 1 may function as an embodiment of the present disclosure. In other words, the imaging apparatus 200 may be provided with the information acquisition unit 312, the shooting range calculation unit 313, the inclusive range setting unit 314, the image retrieval unit 315, the image collection unit 316, and the image combination unit 317 shown in FIG. 6. In this case, the imaging apparatus 200 retrieves the image 70 to be combined from images stored in the flash memory 203 or the like. Further, the imaging apparatus 200 may collect the image 70 to be combined from one or more images stored in the server 400.

Similarly, the PC 290 shown in FIG. 25 may function as an embodiment of the present disclosure. In other words, an image to be combined is retrieved by the PC 290 to generate a panoramic image. It should be noted that in the network system 100′ shown in FIG. 25, an area-missing image or the like may be displayed on a display unit of the PC 290 or the like.

In the description above, the combination candidate image 75 is retrieved from the storage 309 of the server 300 by the image retrieval unit 315 shown in FIG. 6. Then, in the case where all of the necessary combination candidate images 75 are not acquired, the combination candidate images 75 are collected from another server 400 via the network 10 by the image collection unit 316. However, irrespective of the retrieval result of the image retrieval unit 315, the combination candidate images 75 may be collected by the image collection unit 316 via the network 10. Accordingly, many images can be acquired as the combination candidate images 75 and an optimum image can be selected therefrom and adopted as the image 70 to be combined.

In the description above, when an image to be combined (combination candidate image) arranged in the inclusive range is retrieved, the area information (position information and direction information) is referred to. However, tag information on a subject may be added as metadata to a captured image and images stored in each server. Then, images to be combined may be retrieved by referring to the tag information.

For example, when the captured image 50 shown in FIG. 9 or the like is captured, tag information indicating “Mt. Fuji” is added as metadata. Then, an image to which the tag information of “Mt. Fuji” is added is retrieved as the combination candidate image 75 from the images stored in the server 300 or 400. The tag information may be added when a subject is determined based on the shooting position information and shooting direction information. Alternatively, the tag information may be added based on a user operation on the touch panel 205 of the imaging apparatus 200. When such tag information is added, a virtual database can be generated and a panoramic image can be generated with excellent operability even in the following case.

It is assumed that photo shooting is performed in a private home of “Mr. Yamada”, for example, and a panoramic image with the captured image as a reference is intended to be generated. In this case, due to the limitation of GPS module accuracy or the fact that information on the home of Mr. Yamada is not acquired from map information, there may be a case where it is difficult to retrieve images showing the inside of his home. In such a case, if tag information indicating “Home of Mr. Yamada” is added to the captured image or images stored in the server, an image to be combined can be easily retrieved by referring to the tag information.

In addition, any data may be used as metadata referred to when an image to be combined is retrieved.

Image processing such as affine transform may be performed on an image to be combined that is arranged in the inclusive range. Accordingly, a shooting direction of a subject can be adjusted and a panoramic image with excellent accuracy can be generated.

In the description above, a panoramic image is generated as a combined image. According to the present disclosure, however, a 3D image may be generated as a combined image. For example, a shooting range of the image captured by the imaging apparatus is calculated. Then, an inclusive range including at least the shooting range is set. The inclusive range is a range in which images to be combined that are necessary for generating a 3D image are arranged and is, for example, a range corresponding to a field of view obtained when a subject of the captured image is viewed from the periphery and above and below. In other words, as an inclusive range, a virtual canvas is set around (side to side and up and down of) the subject. Then, images to be combined that are arranged in the set inclusive range are retrieved by referring to metadata such as position information. Although a 3D image is generated by combination of the retrieved images to be combined, the user is notified of information on image-missing areas where images to be combined are not arranged, at this time. Accordingly, a highly accurate 3D image can be generated with excellent operability.

In the description above, a captured image to which metadata such as position information is added is transmitted to the server. Then, a subject is determined based on the metadata and a feature point is set. However, a subject may be determined without using the metadata. For example, the color, shape, or the like of the captured subject is detected based on luminance information or the like of the captured image. Then, the subject may be determined based on the information on the color, shape, or the like. In addition, various object recognition technologies can be adopted. Accordingly, the present disclosure is also applicable to a captured image to which metadata is not added so that a combined image such as a panoramic image can be generated with excellent operability.

Further, an image to be input is not limited to a captured image. For example, a sketch of Mt. Fuji may be digitized and image data thereof may be input as an input image. Then, a display range of the digital image may be calculated.

As the images to be combined that are arranged in the inclusive range, for example, an image obtained by photo shooting of a large range including a shooting range of a captured image (for example, wide-angle image) may be retrieved. In this case, a panoramic image may be generated using the wide-angle image or the like instead of the captured image. In other words, a panoramic image may be generated without using the captured image. In the case where a resolution of the wide-angle image or the like is insufficient, the resolution may be increased by resolution conversion processing.

In the description above, three of the interpolation image, area-missing image, and support information are generated. However, one of them may be generated. Further, any two of them may be generated.

In the description above, the shooting advice unit 218 is provided to the imaging apparatus 200. However, a block corresponding to the shooting advice unit 218 may be provided to the server 300 that generates the area-missing image 90 and the support information. In other words, the processing performed on the through-the-lens image 250 as shown in FIG. 24, processing of generating the imaging instruction mark 251, the GUI for the area 252 corresponding to the image-missing area, or the like may be performed by the server 300.

It should be noted that the present disclosure can be configured as follows.

(1) An information processing apparatus, including:

a calculation unit configured to calculate a display range of an input image;

a setting unit configured to set an inclusive range including at least a part of the calculated display range;

a retrieval unit configured to retrieve an image to be combined that is associated with the input image;

an arrangement unit configured to arrange the retrieved image to be combined in the inclusive range;

a determination unit configured to determine an area within the inclusive range, in which the image to be combined is not arranged, as an image-missing area; and

a notification unit configured to notify a user of information on the determined image-missing area.

(2) The information processing apparatus according to Item (1), in which the arrangement unit arranges the image to be combined in the inclusive range based on relevance with the input image.

(3) The information processing apparatus according to Item (1) or (2), in which the notification unit notifies the user of the determined image-missing area in a visualized manner.

(4) The information processing apparatus according to any one of Items (1) to (3), in which the notification unit notifies the user of support information including at least information on a shooting position and a shooting direction, the support information being used for capturing an image to be allocated to the determined image-missing area.

(5) The information processing apparatus according to any one of Items (1) to (4), further including a generation unit configured to generate an interpolation image for interpolating the image-missing area.

(6) The information processing apparatus according to any one of Items (1) to (5), further including a connection unit configured to be connectable via a network to a different information processing apparatus storing one or more images, in which the retrieval unit retrieves via the network the image to be combined from the one or more images stored in the different information processing apparatus.

(7) An information processing method, including:

calculating, by a calculation unit, a display range of an input image;

setting, by a setting unit, an inclusive range including at least a part of the calculated display range;

retrieving, by a retrieval unit, an image to be combined that is associated with the input image;

arranging, by an arrangement unit, the retrieved image to be combined in the inclusive range;

determining, by a determination unit, an area within the inclusive range, in which the image to be combined is not arranged, as an image-missing area; and

notifying, by a notification unit, a user of information on the determined image-missing area.

(8) A program causing a computer to function as:

a calculation unit configured to calculate a display range of an input image;

a setting unit configured to set an inclusive range including at least a part of the calculated display range;

a retrieval unit configured to retrieve an image to be combined that is associated with the input image;

an arrangement unit configured to arrange the retrieved image to be combined in the inclusive range;

a determination unit configured to determine an area within the inclusive range, in which the image to be combined is not arranged, as an image-missing area; and

a notification unit configured to notify a user of information on the determined image-missing area.

(9) An imaging apparatus, including:

an imaging unit configured to capture an image;

a calculation unit configured to calculate a shooting range of the captured image;

a setting unit configured to set an inclusive range including at least a part of the calculated shooting range;

a retrieval unit configured to retrieve an image to be combined that is associated with the captured image;

an arrangement unit configured to arrange the retrieved image to be combined in the inclusive range;

a determination unit configured to determine an area within the inclusive range, in which the image to be combined is not arranged, as an image-missing area; and

a notification unit configured to notify a user of information on the determined image-missing area.

The present disclosure contains subject matter related to that disclosed in Japanese Priority Patent Application JP 2011-019138 filed in the Japan Patent Office on Jan. 31, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a calculation unit configured to calculate a display range of an input image;
a setting unit configured to set an inclusive range including at least a part of the calculated display range;
a retrieval unit configured to retrieve an image to be combined that is associated with the input image;
an arrangement unit configured to arrange the retrieved image to be combined in the inclusive range;
a determination unit configured to determine an area within the inclusive range, in which the image to be combined is not arranged, as an image-missing area; and
a notification unit configured to notify a user of information on the determined image-missing area.

2. The information processing apparatus according to claim 1, wherein
the arrangement unit arranges the image to be combined in the inclusive range based on relevance with the input image.

3. The information processing apparatus according to claim 1, wherein
the notification unit notifies the user of the determined image-missing area in a visualized manner.

4. The information processing apparatus according to claim 1, wherein
the notification unit notifies the user of support information including at least information on a shooting position and a shooting direction, the support information being used for capturing an image to be allocated to the determined image-missing area.

5. The information processing apparatus according to claim 1, further comprising
a generation unit configured to generate an interpolation image for interpolating the image-missing area.

6. The information processing apparatus according to claim 1, further comprising
a connection unit configured to be connectable via a network to a different information processing apparatus storing one or more images, wherein
the retrieval unit retrieves via the network the image to be combined from the one or more images stored in the different information processing apparatus.

7. An information processing method, comprising:
calculating, by a calculation unit, a display range of an input image;
setting, by a setting unit, an inclusive range including at least a part of the calculated display range;
retrieving, by a retrieval unit, an image to be combined that is associated with the input image;
arranging, by an arrangement unit, the retrieved image to be combined in the inclusive range;
determining, by a determination unit, an area within the inclusive range, in which the image to be combined is not arranged, as an image-missing area; and
notifying, by a notification unit, a user of information on the determined image-missing area.

8. A program causing a computer to function as:
a calculation unit configured to calculate a display range of an input image;
a setting unit configured to set an inclusive range including at least a part of the calculated display range;
a retrieval unit configured to retrieve an image to be combined that is associated with the input image;
an arrangement unit configured to arrange the retrieved image to be combined in the inclusive range;
a determination unit configured to determine an area within the inclusive range, in which the image to be combined is not arranged, as an image-missing area; and
a notification unit configured to notify a user of information on the determined image-missing area.

9. An imaging apparatus, comprising:
an imaging unit configured to capture an image;
a calculation unit configured to calculate a shooting range of the captured image;
a setting unit configured to set an inclusive range including at least a part of the calculated shooting range;
a retrieval unit configured to retrieve an image to be combined that is associated with the captured image;
an arrangement unit configured to arrange the retrieved image to be combined in the inclusive range;
a determination unit configured to determine an area within the inclusive range, in which the image to be combined is not arranged, as an image-missing area; and
a notification unit configured to notify a user of information on the determined image-missing area.
